(19) United States
(12) Patent Application Publication
(10) Pub. No.: US 2011/0154714 A1
(43) Pub. Date: Jun. 30, 2011

(54) HOLDER FOR A FISHING ROD

(76) Inventors: TIMOTHY GEORGE RIECK, Prairie Du Chien, WI (US); Tyler Lee Rieck, Prairie Du Chien, WI (US)

(21) Appl. No.: 12/979,320

(22) Filed: Dec. 27, 2010

Related U.S. Application Data
(60) Provisional application No. 61/290,241, filed on Dec. 27, 2009.

(51) Int. Cl. A01K 97/10

(52) U.S. Cl. 43/21.2

(57) ABSTRACT

A holder for a hands free fishing includes an elongated pole. A stake is formed on a bottom end of the elongated pole for insertion into the ground. A V-shaped brace is formed on a top end of the elongated pole for receiving and supporting the fishing rod resting within the brace. In addition, the holder has a footrest above the stake which is for easy insertion and easy removal from the ground. The holder also has a pivotable platform for holding a flashlight at night.

### CROSS-REFERENCE TO RELATED APPLICATION

This application claims the benefit of Provisional Patent Application No. 61/290,241, filed on Dec. 27, 2009, in the United States Patent & Trademark Office, the disclosure of which is incorporated herein by reference.

### BACKGROUND OF THE INVENTION

1. Field of the Invention

The present invention relates to a fishing rod retainer, and more particularly, a holder for a fishing rod.

The present invention allows a person to fish on land in a convenient and hands free manner. The holder remains securely in place and prevents the fishing rod from being pulled into the water, enabling the person to perform other necessary tasks. The present invention eliminates the need to find a stick or other component to prop up the fishing rod. The holder also includes a flashlight to allow for night fishing. The elongated pole of the holder is effectively secured into the ground to provide a more enjoyable and convenient fishing experience.

2. Description of the Prior Art

Many adults and children alike enjoy fishing from a bank or shore of a body of water. Most find it discouraging to put a fishing rod down in order to eat lunch or perform other tasks for fear of losing a potential catch. Many try to prop their fishing rod up against a stick or tree. Some try to balance the fishing rod against their cooler, however this restricts access to the cooler, which is inconvenient. A more efficient method is needed.

Numerous innovations for fishing rod holders have been provided in the prior art that will be described. Even though these innovations may be suitable for the specific individual purposes to which they address, however, they differ from the present invention.

A FIRST EXAMPLE, U.S. Pat. No. 3,410,015, issued on Nov. 12, 1968, to Garcia Jr. teaches a fish rod holder and hook setting device having a pivotally mounted V-shaped holder for the fish rod. The holder is adjustably clamped at one end to a base for selecting the amount of pull necessary for a fish to exert upon the fishing line to move the holder in one direction. This movement of the holder sets off a spring mounted impact means operating to move the holder in an opposite direction so as to snap the holder and line, thereby setting the hook in the mouth of the fish.

A SECOND EXAMPLE, U.S. Pat. No. 3,874,107, issued on Apr. 1, 1975, to Wheaton teaches a combined fishing rod holder and signal device that includes a vertical support member which is driven into the ground. The support member is split into two portions and includes a movable bracket which attaches the two parts and allows them to be adjusted so that the height of the support member can be adjusted as desired. A movable receptacle is connected to the support member and is adapted to receive the handle of a fishing rod which is placed generally upright, parallel to the support. A guide member is disposed vertically above the receptacle and is adapted to co-act with the receptacle and position the handle of the fishing rod as required. A resilient member is pivoted to the support and at the upper extremity thereof, it is affixed to the guide member. A combination alarm and electric power means is connected to the support and the resilient member and a support member are both electrically conductive. A conductive detent is connected to the inner face of the resilient member and that detent is normally spaced from the support member. When a fish is hooked, it pulls on the line and in turn the detent is pulled into contact with the support to complete the circuit and activate the alarm.

A THIRD EXAMPLE, U.S. Pat. No. 4,594,805, Issued on Jun. 17, 1986, to McClelland teaches a support device for a fishing rod to keep that rod and an attached reel out of engagement with the ground. The device is comprised of an elongated base member having a length of about 18 inches and a fixed wall at one end as well as two pivotal walls, one attached at an intermediate position, the other attached at the opposite end. The intermediate wall is positioned from the fixed wall a distance of about 25% to 30% of the length of the base member and the height ratios of the fixed, the intermediate and the end pivoting wall is approximately 1:3:12.

A FOURTH EXAMPLE, U.S. Pat. No. 4,936,039, Issued on Jun. 26, 1990, to Huber et al. teaches a new fishing rod holder and the method of using it, relate to the use of the holder having a stake for insertion into the ground, and a fishing pole holding member, which is swingably connected to the stake and which can be swung to a storage position adjacent to the stake. The fishing rod holding member has a rod receiving portion including a strength imparting neck and a curved lip which cooperate in supporting a fishing rod handle of various different sizes and shapes in a secure manner without any need of adjustment of the rod holding member.

A FIFTH EXAMPLE, U.S. Pat. No. 5,025,584, Issued on Jun. 25, 1991, to Butterwick Sr. teaches an improved fishing rod and reel holding device. The holder consists of an elongated rectangular cross-sectioned base with opposed supports hinged to the base that automatically unfold to the use position when slide of retainer is manipulated to release pressure from the supports. At one end, the supports provide for legs that keep the base off the ground and which are wider than the base thereby helping to stabilize the holder. At the opposite end, the supports provide for grooves which cradle the fishing rod and reel so that a fisherman can easily grab the fishing rod when a fish strikes the line. For ease of storage and for carrying, the supports fold toward each other so that they lie adjacent to the top side of the base where they can be secured by the retainer.

A SIXTH EXAMPLE, U.S. Pat. No. 5,063,373, issued on Nov. 5, 1991, to Lindsley teaches a fishing rod holder that incorporates a sensing device to monitor the tension on the fishing line. When the tension increases, this device triggers either a sound or a visual alarm, according to the chosen operational mode, and alerts the fisherman as soon as a first strike occurs. The holder features a pointed tip for easy penetration and a foot rest for applying downward pressure while inserting it into the ground. Its construction consists of a sturdy main frame and a detachable alarm unit for durability and convenience of transportation. When assembled, the alarm unit can be adjusted to vary its position with respect to the rod and its sensitivity to tension in the line.

A SEVENTH EXAMPLE, U.S. Pat. No. 5,557,877, issued on Sep. 24, 1996, to Colson teaches a universal mount fishing rod holder for holding a plurality of fishing rods in a position for use when fishing including a rigid planar base coupled to a tubular receptacle; a coupling mechanism for securing the base to an external recipient object; a rigid planar bar positioned above the base; an elongated support rod having one end removably coupled within the receptacle of the base and another end pivotally coupled to the bar; and a plurality of spaced and parallely aligned rod holders with each rod holder formed of an elongated rigid piece of wire having an anterior section with a generally v-shaped seat for holding a portion of a fishing rod, a posterior section with a loop for receiving an end of a fishing rod, and a central section extended therebetween and coupled to the bar.

AN EIGHTH EXAMPLE, U.S. Pat. No. 6,253,484, issued on Jul. 3, 2001, to O'Connor teaches a fishing rod holder includes a first leg having an inner edge in direct contact with an inner surface of a vertical sidewall of a bucket or other support object. A second leg having a length shorter than the first leg is disposed parallel to the first leg. The second leg is in direct contact with an outer surface of the vertical sidewall of the bucket. The first leg and the second leg define a slot which receives the vertical sidewall. An arm extends from an upper end of the second leg. The arm includes a first portion extending upward from the second leg at an angle away from the first leg and a second portion extending upward from the arm first portion at a negative angle. The arm lower and upper portions each include an inner side. A bridge spans a top end of the first leg and an upper end of the second leg, interconnecting the first leg and the second leg. The bridge includes a side extending upward from the inner side of the arm lower portion in parallel relation with the inner side of the arm upper portion. The side of the bridge and the inner sides of the arm lower and upper portions define a channel for supporting a fishing rod.

A NINTH EXAMPLE, U.S. Pat. No. 6,338,465, issued on Jan. 15, 2002, to Stoner teaches a fishing rod holder comprising: a frame adapted to support and pivotally hold a at least one fishing rod, the frame having an anteriorly disposed side and a posteriorly disposed side, each opposing the other, and opposing sides, the anteriorly disposed side having a plurality of anterior fishing rod accommodations, and the posteriorly disposed side having plurality of corresponding inverted posterior fishing rod accommodations; a support member for supporting the frame; at least one supplementary strut therebetween the frame and the support member; and mounting means adapted to mount the fishing rod holder thereonto a surface. The fishing rod holder is simple, effective, lightweight, durable, capable of allowing quick and easy access, installation, and removal of at least one and a plurality of fishing rods thereon and therefrom, respectively, and requiring no assembly or minimal assembly, inexpensive, attractive, quick and easy to install and remove therefrom a surface, being removably attachable therefrom, compactly storable, and may be configurated and of unitary construction. The fishing rod holder is capable of removably holding at least one fishing rod thereon having the fishing rod angularly disposed at an attitude, and is adapted to removably hold a plurality of fishing rods angularly offset one from the other, to minimize the chances of lines from each of the fishing rods entangling one another. The fishing rod holder is capable of being removably engaged thereinto the ground, or removably mounted thereonto other surfaces, such as of a dock, railing, or boat.

A TENTH EXAMPLE, U.S. Pat. No. 7,086,194, issued on Aug. 8, 2006, to Troyer Jr. teaches an apparatus includes a rigid frame that has a plurality of integrally connected support sections for defining an anchor. The apparatus further includes an elongate and tubular shaft for receiving a proximal end portion of the fishing rod. The tubular shaft has a top end portion pivotally attached to the anchor frame such that the tubular shaft can be articulated along an arcuate path. The tubular shaft extends substantially orthogonal to the anchor frame when biased to the operating position. A mechanism is included for automatically notifying the user when a fish has engaged the bait. The notifying mechanism is operably engaged with the tubular shaft and the anchor frame while protruding forwardly therefrom and towards a body of water.

AN ELEVENTH EXAMPLE, U.S. Patent Office Publication No. 2008/0016750, published on Jan. 24, 2008, to Benton teaches a collapsible fishing rod holder and includes at least one base jointed member, a branch ready jointed member removably joinable to at least one base jointed member and having a first branch joint, a first branch member removably joinable to the first branch joint, and a second branch member at an acute angle in relation to the first branch member. In another embodiment, second branch member is removably joinable to the second branch joint. In another embodiment, base jointed members, branch ready jointed member, and at least one branch member, are hollow, and a tensioned line runs into and through each member. In another embodiment, member connecting sleeves on the branch ready joint member and base jointed members, connect the branch ready jointed member to a base jointed member and base jointed members to another base jointed member. In another embodiment, a member connecting sleeve on the second branch member connects the second branch member to the branch ready jointed member. In another embodiment, a base member end tip is located on the end of the final base jointed member, allowing the holder to be placed into the ground or a stand.

A TWELFTH EXAMPLE, U.S. Patent Office Publication No. 2008/0115401, published on May 22, 2008, to Roemer et al. teaches a fishing rod carrier and holder device that holds a plurality of fishing rods during fishing activity and houses the fishing rods when the device is being carried. The fishing rod carrier and holder device includes a support member having a spiked portion appointed for insertion into a ground surface. The support member includes a first horizontal plate having at least two rod holder apertures that define an aperture housing interrupted by an entry port. Additionally, the support member is provided with a second horizontal plate having at least two rod receiving cavities arranged in parallel longitudinal relation to the rod holder apertures of the first horizontal plate. The fishing rod carrier and holder device has at least one handle portion arranged to allow the fishing rod carrier and holder device to be carried with the fishing rods therein housed.

It is apparent now that numerous innovations for fishing rod holders have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a holder for a fishing rod that avoids the disadvantages of the prior art.

ANOTHER OBJECT of the present invention is to provide a holder for a fishing rod that is simple and inexpensive to manufacture.

STILL ANOTHER OBJECT of the present invention is to provide a holder for a fishing rod that is simple to use.

BRIEFLY STATED, STILL YET ANOTHER OBJECT of the present invention is to provide a holder for a fishing rod which comprises an elongated pole. A stake is formed on a bottom end of the elongated pole for insertion into the ground. A brace is formed on a top end of the elongated pole for receiving and supporting the fishing rod resting within the brace.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a perspective view of the present invention in use;

FIG. 2 is a perspective view of the present invention per se;

FIG. 3 is an enlarged perspective view of a portion of the present invention showing the V-shaped cradle in greater detail;

FIG. 4 is an enlarged perspective view of a portion of the present invention showing a flashlight secured to the adjustable platform with a VELCRO strap; and

FIG. 5 is an enlarged perspective view of a portion of the present invention showing the flashlight secured to the adjustable platform with a clip.

### REFERENCE NUMERALS UTILIZED IN THE DRAWING

110 holder
112 fishing rod
114 elongated pole of holder 110
116 stake of holder 110
118 ground
120 brace of holder 110
122 footrest of holder 110
124 V-shaped cradle of brace 120
126 safety bar of brace 120
128 triangular shaped plate for footrest 122
130 platform of holder 110
132 pivot of platform 130
134 flashlight of holder 110
136 removably attaching mechanism of holder 110
138 hook and loop fastener strap for mechanism 136
140 clip for mechanism 136

### DESCRIPTION OF THE PREFERRED EMBODIMENT

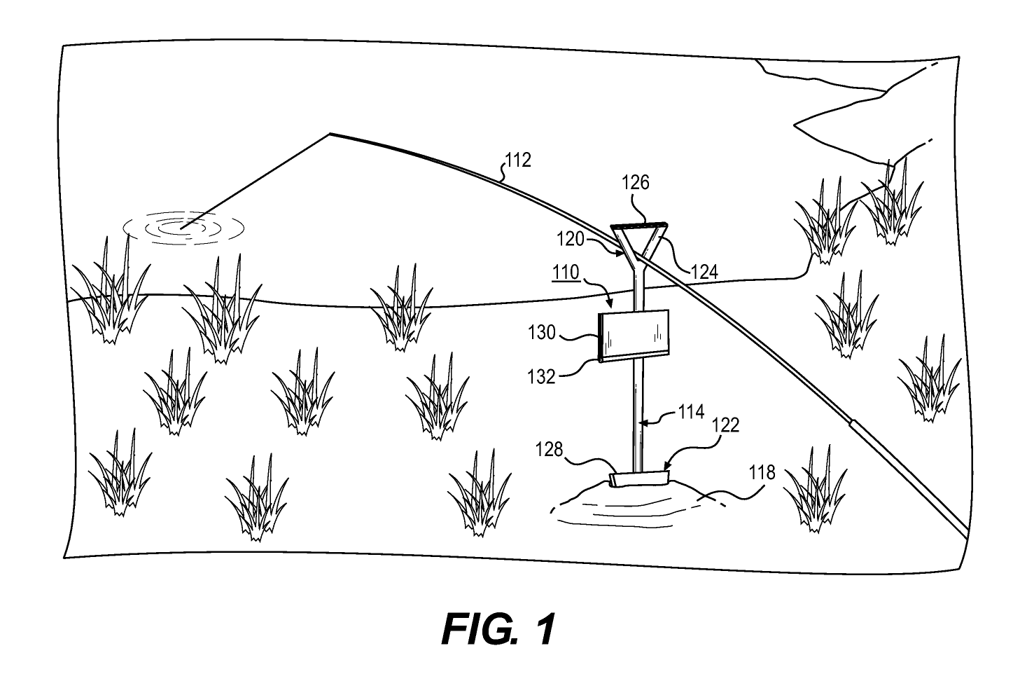

Referring now to the figures, in which like numerals indicate like parts, and particularly to FIGS. 1 through 5, and as such, will be discussed with reference thereto.

In FIG. 1: a holder 110 for a fishing rod 112 which comprises an elongated pole 114. A stake 116 is formed on a bottom end of the elongated pole 114 for insertion into the ground 118. A brace 120 is formed on a top end of the elongated pole 114 for receiving and supporting the fishing rod 112 resting within the brace 120.

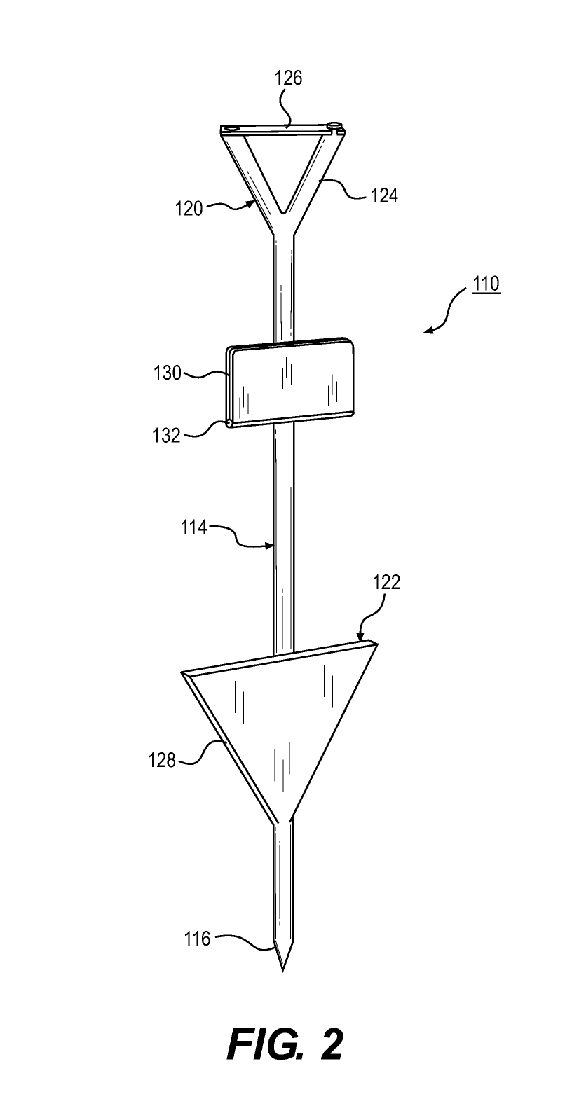

In FIG. 2: the holder 110 further comprises a triangle footrest 122 on the elongated pole 114 above the stake 116, whereby the stake 116 can be pushed into the ground 118 by applying pressure onto the footrest 122 to stabilize the elongated pole 114 in a stationary vertical position. The stabilization is done by anti-rotation and anti-bending so the pole 114 can be firmly in a vertical position. A downward vertex of the triangle footrest 122 can also be inserted to the ground. The other two vertices are formed a horizontal line so the foot can step on. The brace 120 comprises a V-shaped cradle 124. A safety bar 126 connects horizontally to opposite upper ends of the V-shaped cradle 124 to secure the fishing rod 112 in place.

The footrest 122 comprises a triangular shaped plate 128 affixed vertically against the elongated pole 114 above the stake 116. The plate 128 can be a triangle with equilateral, equiangular or isosceles.

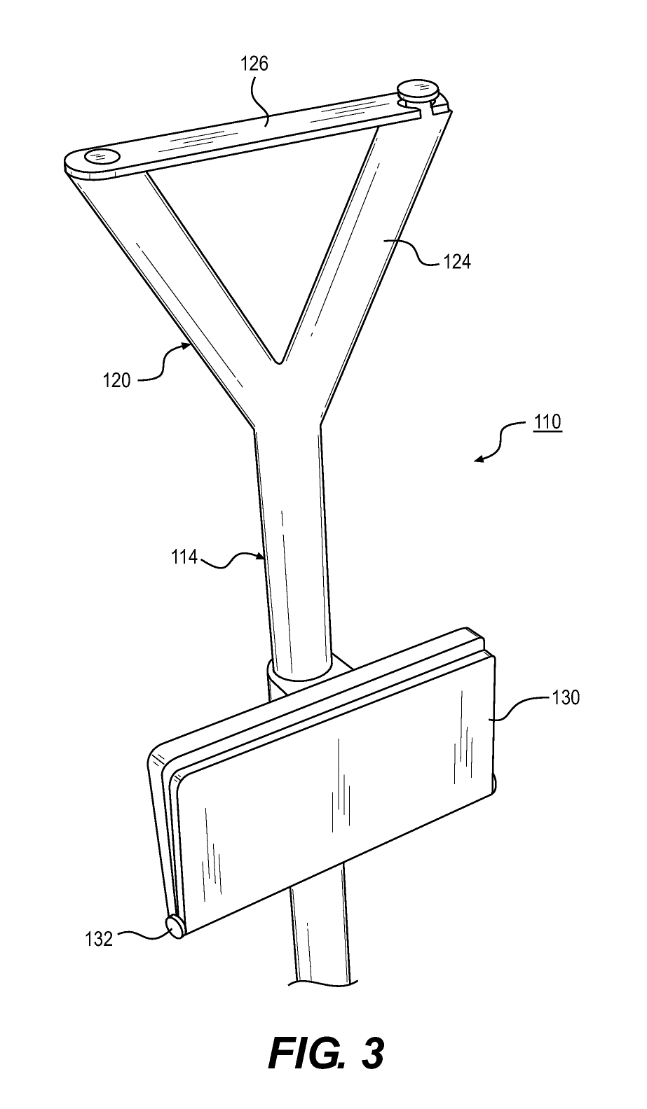

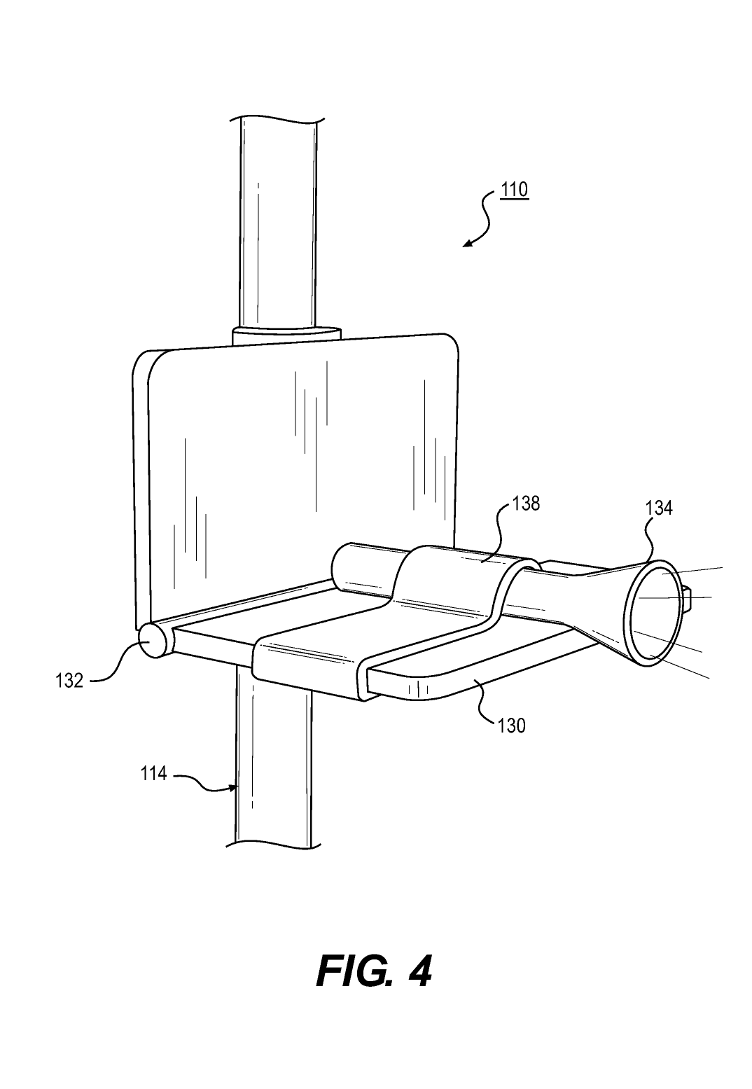

In FIGS. 3-4: a platform 130 is adjustably mounted to a rectangular base by a pivot 132 against the elongated pole 114 below the brace 120 and above the triangle footrest 122. The platform 130 can be pivotably closed from a vertical position and opened to an horizontal position.

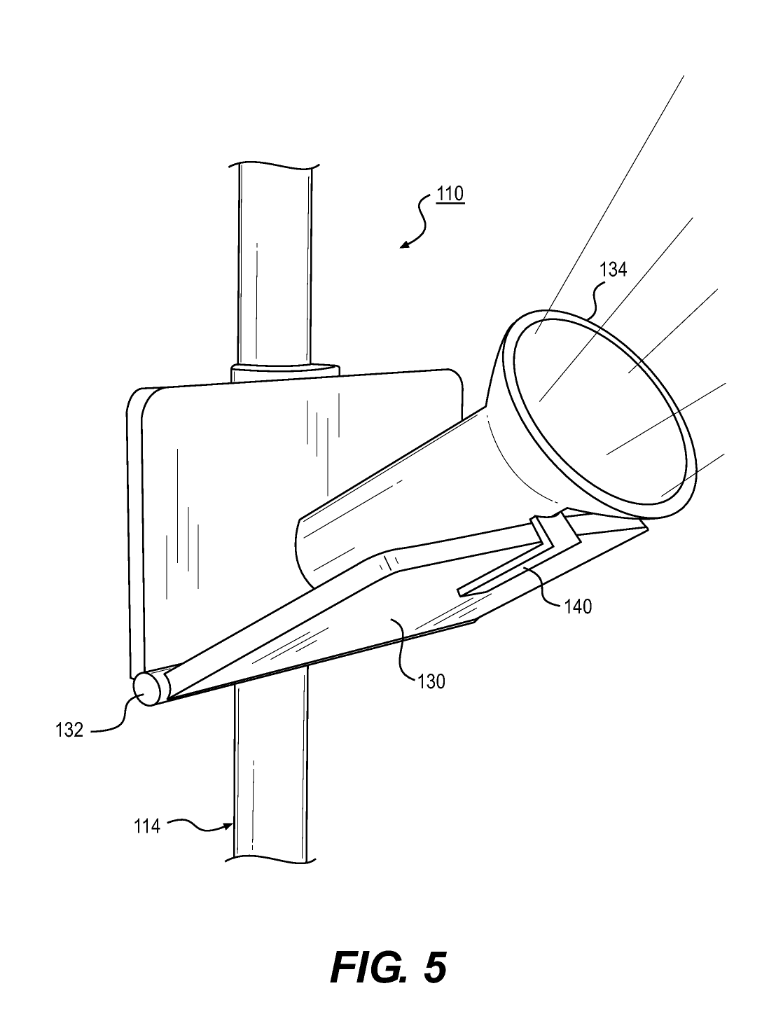

In FIG. 5: the platform 130 can be angled from zero to ninety (90) degrees at user's selection. A flashlight 134 is provided. A mechanism 136 is for removably attaching the flashlight 134 onto the platform 130 to provide illumination at night. The removably attaching mechanism 136 comprises a hook and loop fastener strap 138 to hold the flashlight 134 onto the platform 130. The removably attaching mechanism 136 can also be a clip 140 on the flashlight 134 to hold the flashlight 134 onto the platform 130.

In summary, the holder 110 is constructed to allow users to secure their fishing rod 112 for hands free fishing. The present invention is made to be inserted into the ground 118. The holder 110 consists of an elongated pole 114 that has a footrest 122 being a triangular plate 128 attached near the stake 116. The triangular shaped plate 128 extends past the elongated pole 114 on both sides by about two (02) inches. The triangular shaped plate 120 is used to push the elongated pole 114 into the ground 118 by using a foot of the user. The triangular plate 128 also helps to pull out the pole easily when the pole 114 is no longer in use.

The top of the elongated pole 114 has a brace 120 that consists of a V-shaped cradle 124. This is where the fishing rod 122 is held. One top side of the V-shaped cradle 124 contains a safety bar 126 that will connect to the opposite top side of the V-shaped cradle 124. This will secure the fishing rod 112 in place. The V-shaped cradle 124 has to be on the same surface plane with the triangular shaped plate 128. A flashlight 134 is placed on a platform 130 and is removably attached by a mechanism 136 being a hook and loop fastener strap 138, a clip 140, or other suitable component. The flashlight 134 is placed between the stake 116 and the V-shaped cradle 124 on the platform 130. The platform 130 can be easily adjusted to various angles by a pivot 132 depending on user preferences. The holder 110 measures approximately thirty two and a half inches (32.5) in height. The elongated pole, footrest, platform, and brace of holder 110 are made from a group consisting of plastic, wood and non-corrosive metal. The exact specifications may vary.

It will be understood that each of the elements described above, or two or more together, may also find a useful application in other types of constructions differing from the types described above.

While the invention has been illustrated and described as embodiments of a holder for a fishing rod, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A holder for a fishing rod in hands-free fishing which comprises:
a) an elongated pole;
b) a stake formed on a bottom end of the elongated pole for insertion into the ground; and
c) a brace formed on a top end of the elongated pole for receiving and supporting the fishing rod resting within the brace, and
d) a triangle footrest on the elongated rod above the stake, whereby the stake can be further pushed into the ground by putting a foot down on the footrest to make a downward vertex of the triangle footrest going deep into the ground to further stabilize the elongated rod in a stationary vertical position.

2. The holder as recited in claim 1, wherein the brace comprises:
a) a V-shaped cradle which is on the same surface plane with the triangle footrest; and
b) a safety bar that connects horizontally to opposite upper ends of the V-shaped cradle to secure the fishing rod in place.

3. The holder as recited in claim 1, wherein the footrest comprises a triangular shaped plate affixed vertically against the elongated pole and located above the stake.

4. The holder as recited in claim 3, wherein the plate can be a triangle with equilateral, equiangular or isosceles.

5. The holder as recited in claim 3, wherein the triangular shaped plate extends past the elongated pole on both sides by about two (02) inches.

6. The holder as recited in claim 2, further comprising:
a) a platform adjustably mounted by a pivot against the elongated pole below the brace and above the footrest; wherein the platform's angle is adjusted by a user's preference.
b) a flashlight; and
c) means for removably attaching the flashlight onto the platform to provide illumination at night.

7. The holder as recited in claim 4, wherein the removably attaching means comprises a hook and loop fastener strap to hold the flashlight onto the platform.

8. The holder as recited in claim 4, wherein the removably attaching means comprises a clip on the flashlight to hold the flashlight onto the platform.

9. The holder as recited in claim 1, wherein the elongated pole is about 32.5 inches.

10. The holder as recited in claim 1, wherein the elongated pole is made from a group consisting of plastic, wood and non-corrosive metal.
